(19) United States
(12) Patent Application Publication
(10) Pub. No.: US 2003/0092432 A1
(43) Pub. Date: May 15, 2003

(54) Method and apparatus for providing a caller id including an advertisement

(76) Inventor: Woo-Won Hwang, Seoul (KR)

Correspondence Address: PERKINS COIE LLP, PATENT-SEA, P.O. BOX 1247, SEATTLE, WA, 98111-1247, US

(21) Appl. No.: 10/220,135

(22) PCT Filed: Jan. 31, 2002
(86) PCT No.: PCT/KR02/00139

(30) Foreign Application Priority Data
Jul. 31, 2001 (KR) 2001/0004726
Jul. 24, 2001 (KR) 2001/0044392

(51) Int. Cl. H04M 11/00; H04M 1/56; H04M 15/00; H04M 1/64

(52) U.S. Cl. 455/415; 379/142.01; 379/142.07; 379/114.13; 379/88.15; 379/88.21; 455/414

(57) ABSTRACT

The present invention relates to a caller identification display service method and apparatus for providing caller identification and additional information like an advertisement or an official announcement on a recipient's telephone. According to the present invention the method of displaying the caller identification and the additional information on the recipient's telephone comprises the steps of receiving a call request from a caller's telephone terminal, extracting the additional information corresponding to the caller identification from a database in response to the call request, and transmitting a paging signal comprising the additional information and the caller identification to the recipient's telephone terminal, wherein the additional information and the caller identification are displayed on the recipient's telephone terminal.

### TECHNICAL FIELD

The present invention relates to a caller identification displaying method and system for providing a caller identification(the caller's telephone number) and additional information like an advertisement or a notice.

### BACKGROUND OF THE INVENTION

The present invention relates to a caller identification displaying method and system for providing a caller identification(the caller's telephone number) and additional information like an advertisement or a notice.

The caller identification service is the service displaying the caller's telephone number on a recipient's telephone or terminal before the call is accepted.

Because the caller identification service displays the caller's telephone number on the recipient's telephone, interference in another's private life via telecommunication like an anonymous prank phone call or an obscene phone call can be prevented.

Also, because the caller identification service displays the caller's telephone number on the recipient's telephone, the recipient can confirm the displayed caller identification and receive the call selectively.

The caller identification display service displays the caller's information (e.g., caller identification, name and so on), on the subscriber's telephone terminal before the call begins or when the subscriber is on the telephone.

Also, because the caller identification display service displays the caller's information (name and telephone number) for the call that occurred while the subscriber was out, the subscriber can view the received call list. The subscriber can call the caller corresponding to the displayed telephone number and view the telephone number of the call received while the subscriber is on the telephone.

According to the conventional caller identification display service, the telephone terminal stores the caller identification (i.e., the caller's telephone number), received from a base station in certain order. The subscriber can search the stored caller identification(the caller's telephone number) and call the caller corresponding to the caller identification.

FIG. 1 is a schematic diagram of a personal communication system corresponding to the TDMA method in the convention.

Referring FIG. 1, the personal communication system comprises a terminal 109, a base station 107, a base station controller, a switch, an authentication center and so on.

The terminal 109 is a mobile telephone terminal. The base station 107 receives data of the GSM (Global System for Mobile communication) method from a terminal 109 and transmits the data to the other terminal 109. Also, the base station 107 transmits and receives the mobile signal of the terminal 109 and converts a communication protocol and executes encryption/decryption.

The base station controller 105 manages the base station 107 and assigns communication channels to each terminal 109 and decides about a hand over for each terminal 109.

The switch 101 connects the base station controller 105 with a central office or connects a central office switch with the authentication center 103. Also, the authentication center 103 approves the terminal usage and executes an accounting by having the serial number of the terminal 109.

Generally, in the mobile communication system of the GSM method, the communication is accomplished by the transmitting-receiving between the base station 107 and the mobile terminal 109. And the control data comprises the caller's telephone number provided for the recipient(subscriber).

Because the caller identification display service is not concerned with a telephone call, the caller identification display service can be provided as additional service. And the caller's telephone number can be transmitted to the terminal 109 by being added to the call data that is emitted through the paging channel. Also, simultaneously when the traffic channel is assigned, the caller's telephone number can be transmitted to the terminal 109 through the traffic channel. Accordingly, the caller id (the caller's telephone number) is properly transmitted to the recipient with the call data in order for the recipient to perceive who the caller is before the conversation is initiated.

In the conventional service, the terminal 109 stores the caller's telephone number (the caller id), which is transmitted from the base station 107, on the memory of the terminal 109. And the recipient can search the stored caller identification through the key input unit of the terminal 109.

As described above, the recipient can search the caller's telephone number and call the caller by using the caller identification display service. In the conventional service, some problems exist such as the caller identification display service cannot display an advertisement or additional information on the terminal 109.

Also, according to the conventional caller identification display service, because the caller's telephone number is only displayed on the recipient's telephone 109, the recipient cannot perceive who the caller is based on the telephone call called from a stranger.

Therefore, one object of the present invention is to provide a caller identification display method and system for displaying not only the caller identification (the caller's telephone number) but also additional information like an advertisement.

Another object of the present invention is to provide a caller identification display method and system whereby the telecommunications operator provides the caller identification and an advertisement together.

Still another object of the present invention is to provide a caller identification display method and system in which the recipient can perceive the caller's identification of the call when receiving a call from a stranger (i.e., a strange person or a strange company), by displaying not only the caller's telephone number but also an advertisement or an image corresponding to the caller on the recipient's telephone terminal.

### SUMMARY OF THE INVENTION

To accomplish the objects of the present invention according to one preferred embodiment of the present invention, a method is provided for receiving a call request from a caller's telephone terminal, extracting the additional information corresponding to the caller identification from a database in response to the call request, and transmitting a paging signal comprising the additional information and the caller identification to the recipient's telephone terminal, wherein the additional information and the caller identification are displayed on the recipient's telephone terminal.

The additional information and the caller identification are stored on the recipient's telephone terminal.

The stored additional information is searched and selected by the recipient's key input.

The recipient's telephone terminal displays the additional information and the caller identification on the indicator of the terminal at a time.

The recipient's telephone terminal displays the additional information and the caller identification on the indicator of the terminal alternately.

The additional information is extracted from at least one selected from the group consisting of the recipient and the caller.

The additional information is extracted corresponding to the caller identification.

The additional information is at least one selected from the group consisting of an advertisement, notice, news, mail address, information, and service.

The recipient's telephone terminal calls the caller corresponding to the caller identification in response to the recipient's key input.

The caller identification is at least one selected from the group consisting of the caller's telephone number, subscriber identification, a name, and a mail address.

To accomplish the objects of the present invention according to another preferred embodiment of the present invention, a method is provided for receiving a paging signal comprising a caller identification and additional information corresponding to the caller, setting up a speech path of the caller's telephone terminal corresponding to the caller identification, determining whether or not the call is over, determining whether or not the pointer is the end of memory after the call is over, and if the pointer is the end of memory, then moving the pointer to the beginning of memory but if the pointer is not the end of memory, then moving the pointer to the next of memory, storing the caller identification and the additional information on the moved pointer, receiving a caller identification searching request from the recipient, reading the caller identification and the additional information corresponding to the current point and displaying the caller identification and the additional information in the indicator at a time.

To accomplish the objects of the present invention according to another preferred embodiment of the present invention, a method is provided for receiving a paging signal comprising a caller identification and additional information corresponding to the caller, setting up a speech path of the caller's telephone terminal corresponding to the caller identification, determining whether or not the call is over, determining whether or not the pointer is the end of memory after the call is over, if the pointer is the end of memory then moving the pointer to the beginning of memory, but if the pointer is not the end of memory then moving the pointer to the next of memory and storing the caller identification and the additional information on the moved pointer, wherein the additional information is displayed on the recipient's telephone terminal in response to the recipient's searching request.

The recipient's telephone terminal displays the additional information and the caller identification on the indicator of the terminal at a time.

The recipient's telephone terminal displays the additional information and the caller identification on the indicator of the terminal alternately.

The telecommunication operator corresponding to the recipient's telephone terminal randomly extracts the additional information.

The additional information is extracted from at least one selected from the group consisting of the recipient and the caller.

The additional information is extracted corresponding to the caller identification.

The additional information is at least one selected from the group consisting of an advertisement, a notice, news, a mail address, information, and a service.

The recipient's telephone terminal calls the caller corresponding to the caller identification in response to the recipient's key input.

The caller identification is at least one selected from the group consisting of the caller's telephone number, subscriber identification, a name, and a mail address.

To accomplish the objects of the present invention according to another preferred embodiment of the present invention, a method is provided for receiving a caller identification searching request from the recipient, extracting the caller identification and the additional information corresponding to the current point from the memory of the recipient's telephone terminal, and displaying the caller identification and the additional information in the indicator of the recipient's telephone terminal, wherein the caller identification and the additional information are stored on the recipient's telephone terminal in response to the call request received from the caller's telephone terminal.

The recipient's telephone terminal displays the additional information and the caller identification on the indicator of the terminal at a time.

The recipient's telephone terminal displays the additional information and the caller identification on the indicator of the terminal alternately.

The telecommunication operator corresponding to the recipient's telephone terminal randomly extracts the additional information.

The additional information is extracted by at least one selected from the group consisting of the recipient and the caller.

The additional information is extracted corresponding to the caller identification.

The method for displaying a caller identification and additional information further comprising the steps of receiving a call request from the recipient and setting up a speech path of the caller's telephone terminal corresponding to the caller identification.

The additional information is at least one selected from the group consisting of an advertisement, a notice, news, a mail address, information, and a service.

The recipient's telephone terminal calls the caller corresponding to the caller identification response to the recipient's key input.

The caller identification is at least one selected from the group consisting of the caller's telephone number, subscriber identification, a name, and a mail address.

To accomplish the objects of the present invention according to another preferred embodiment of the present invention, a method is provided for receiving a call request from the recipient, extracting the additional information identification corresponding to the caller identification from a database in response to the call request and transmitting a paging signal comprising the additional information identification and the caller identification to the recipient's telephone terminal, wherein the additional information corresponding to the additional information identification and the caller identification are displayed on the recipient's telephone terminal.

To accomplish the objects of the present invention according to another preferred embodiment of the present invention, a method is provided for receiving a paging signal comprising a caller identification and additional information identification corresponding to the caller, setting up a speech path of the caller's telephone terminal corresponding to the caller identification, determining whether or not the call is over, determining whether or not the pointer is the end of memory after the call is over, and if the pointer is the end of memory then moving the pointer to the beginning of memory, but if the pointer is not the end of memory then moving the pointer to the next of memory, storing the caller identification and the additional information identification on the moved pointer, receiving a caller identification searching request from the recipient, reading the caller identification and the additional information identification corresponding to the current point, extracting the additional information corresponding to the additional information identification from the memory of the recipient's telephone terminal and displaying the caller identification and the additional information in the indicator at a time, wherein the additional information is stored corresponding to the additional information identification, and if the extracted additional information does not exist, then the recipient's telephone terminal transmits an additional information request comprising the additional information identification to the additional information providing apparatus.

To accomplish the objects of the present invention according to another preferred embodiment of the present invention, a method is provided for receiving a paging signal comprising a caller identification and additional information identification corresponding to the caller, setting up a speech path of the caller's telephone terminal corresponding to the caller identification, determining whether or not the call is over, determining whether or not the pointer is the end of memory after the call is over, and if the pointer is the end of memory then moving the pointer to the beginning of memory, but if the pointer is not the end of memory then moving the pointer to the next of memory and storing the caller identification and the additional information identification on the moved pointer, wherein the additional information corresponding to the additional information identification is extracted in response to the caller identification searching request of the recipient and displayed on the recipient's telephone terminal, and if the extracted additional information does not exist, then the recipient's telephone terminal transmits an additional information request comprising the additional information identification to the additional information providing apparatus.

To accomplish the objects of the present invention according to another preferred embodiment of the present invention, a method is provided for receiving a caller identification searching request from the recipient, extracting the caller identification and the additional information identification corresponding to the current point from the memory of the recipient's telephone terminal, extracting the additional information corresponding to the additional information identification from the memory of the recipient's telephone terminal and displaying the caller identification and the additional information in the indicator of the recipient's telephone terminal, wherein the caller identification and the additional information identification are stored on the recipient's telephone terminal in response to the call request received from the caller's telephone terminal, and the additional information is stored corresponding to the additional information identification, but if the extracted additional information does not exist then the recipient's telephone terminal transmits an additional information request comprising the additional information identification to the additional information providing apparatus.

### BRIEF DESCRIPTIONS OF THE DRAWINGS

The above objects and other advantages of the present invention will become more apparent by detailed descriptions of the preferred embodiments thereof with reference to the attached drawings, in which:

FIG. 1 is a schematic diagram of personal communication system corresponding to the TDMA method in the conventional service.

FIG. 2 is a schematic diagram of the caller identification display system displaying the caller identification and an advertisement in the present invention.

FIG. 3 is a block diagram of the telephone terminal displaying the caller identification and an advertisement in the present invention.

FIG. 4 is an example of the display monitor displaying the caller identification and the advertisement at a time in the present invention.

FIG. 5 is an example of the display monitor displaying the caller identification and the advertisement alternately in the present invention.

FIG. 6a and FIG. 6b comprise a flowchart illustrating the process of storing an advertisement provided in the caller identification display service of the present invention.

FIG. 7 is a flowchart illustrating the process of displaying the caller identification and the advertisement at a time in the present invention.

FIG. 8 is a flowchart illustrating the process of displaying the caller identification and the advertisement alternately in the present invention.

FIG. 9a and FIG. 9b comprise an example of the display monitor displaying the caller identification and the advertisement in the present invention.

FIG. 10a and FIG. 10b comprise the other flowchart illustrating the process of storing an advertisement provided in the caller identification display service of the present invention.

FIG. 11a and FIG. 11b comprise the other flowchart illustrating the process of displaying the caller identification and the advertisement at a time in the present invention.

FIG. 12a and FIG. 12b comprise the other flowchart illustrating the process of displaying the caller identification and the advertisement alternately in the present invention.

<A key to numerical references to the major parts of the drawings>

101 . . . call center

103 . . . authentication center

105 . . . base station controller

107 . . . base station

109 . . . terminal

201 . . . advertisement information providing apparatus

203 . . . advertisement database

301 . . . microphone

303 . . . speaker

305 . . . voice processor

307 . . . LAPDm processor

309 . . . base band processor

311 . . . modulator

313 . . . authentication center

315 . . . demodulator

317 . . . authentication center

319 . . . A/D converter

321 . . . key input unit

323 . . . controller

325 . . . indicator

327 . . . program memory

329 . . . data memory

331 . . . caller identification memory

333 . . . advertisement memory

Embodiment

Hereinafter, preferred embodiments of the present invention will be described in more detail with reference to the accompanying drawings, but it is understood that the present invention should not be limited to the following embodiments.

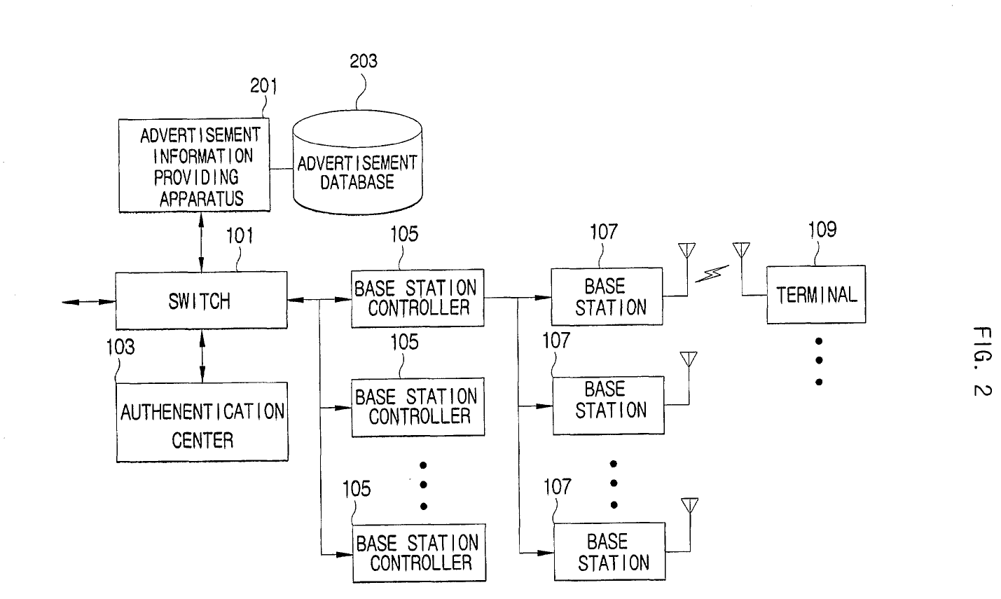

FIG. 2 is a schematic diagram of the caller identification display system displaying the caller identification and an advertisement in the present invention.

Referring to FIG. 2, the caller identification display system comprises a terminal 109, a base station 107, a base station controller 105, a switch 101, an authentication center 103, an advertisement information providing apparatus 201 and so on.

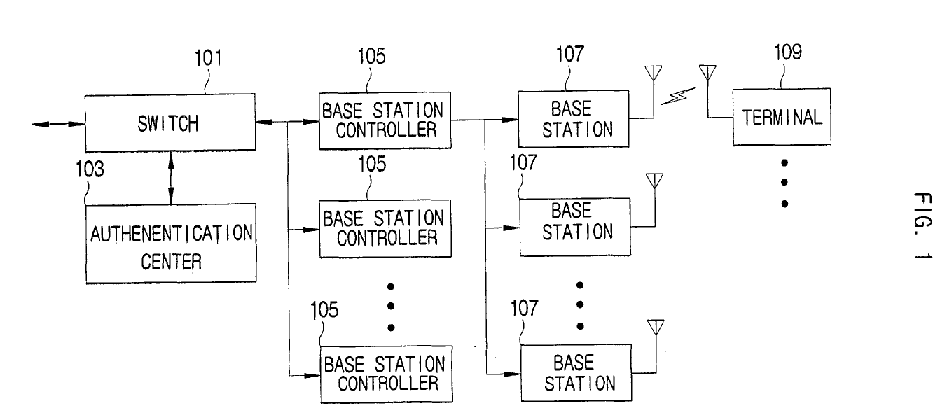

The composition and operation of the terminal 109, the base station 107, the base station controller 105, the switch 101 and the authentication center 103 are same as described at FIG. 1.

The terminal 109 comprises PSTN(Public Switched Telephone Network) terminal, CDMA(Code-Division Multiple Access) terminal, PCS(Personal Communications Services) terminal, PDA(Personal Digital Assistant), IMT-2000(Internet Mobile Telecommunications-2000) and so on. If the terminal 109 supports an image, then the caller identification and the additional information, which is image type or moving picture type, can be provided.

In the present invention, the caller identification display system provides the caller's telephone number and an advertisement on the recipient's terminal 109. In order to provide this, the switch 101 is connected with the advertisement information providing apparatus 201, and the advertisement information providing apparatus 201 is coupled with an advertisement database 203.

The system stores an advertisement(text, image and so on), which is provided for the recipient's terminal 109, on the advertisement database 203 Also, the advertisement information providing apparatus 201 extracts an advertisement from the advertisement database 203 randomly or extracts an advertisement corresponding to the recipient from the advertisement database 203. The extracted advertisement and the caller's telephone number are transmitted to the base station 107 through the switch 101.

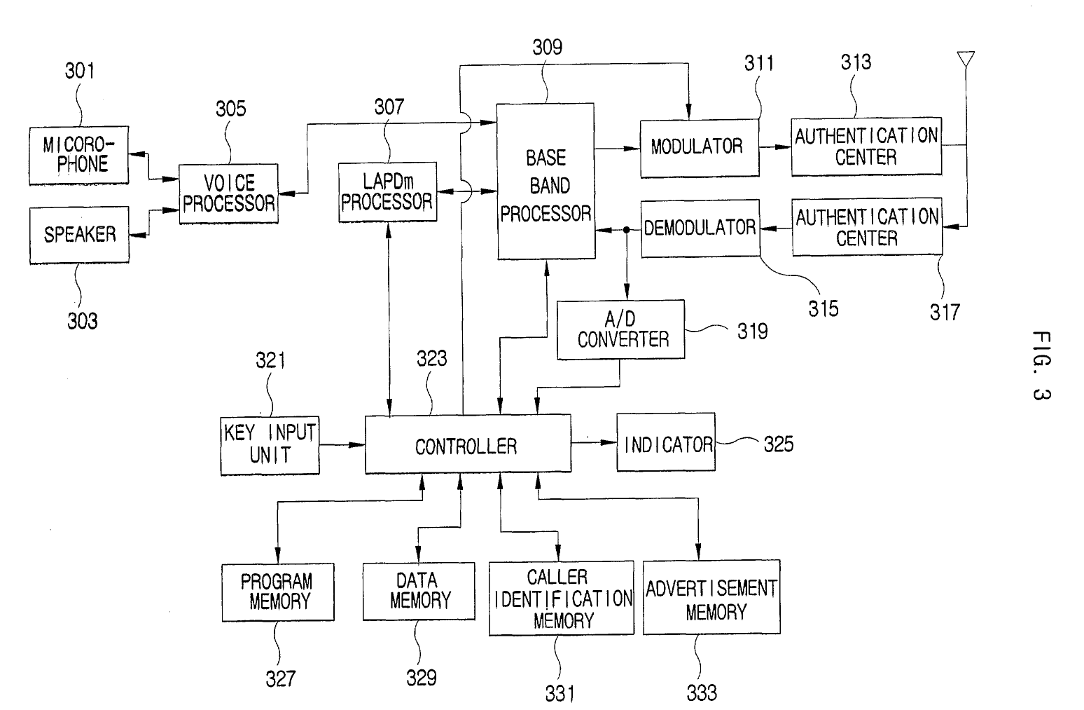

If the base station 107 receives the advertisement and the caller's telephone number, then the base station 107 transmits them to the recipient's telephone terminal 109. If the terminal 109 receives the advertisement and the caller's telephone number, then the terminal 109 displays them through the indicator 325(Refer to FIG. 3) of the terminal 109. At this point, the advertisement and the caller's telephone number can be displayed on the indicator 325 at the same time or can be alternately displayed.

The advertisement and the caller's telephone number are stored in the memory of the terminal 109 and are searched by the recipient. The recipient searches the stored caller's telephone number by using the key input unit of the terminal 109 and calls the caller by using the caller's telephone number.

FIG. 3 is a block diagram of the telephone terminal displaying the caller identification and an advertisement in the present invention.

Referring to FIG. 3, the terminal 109 comprises an antenna, a low noise amplification unit, a demodulator 315, a base band processor 309 and LAPDm processor 307.

Also, the terminal 109 further comprises a speaker 303, a microphone 301, a voice processor 305, a modulator 311, and an amplifier.

Also, the terminal 109 further comprises a key input unit 321, an indicator 325, a controller 323, a program memory 327, a data memory 329, and A/D converter 319.

Also, the terminal 109 further comprises a caller identification memory 331 and an advertisement memory 333.

The antenna receives and transmits data, and the low noise amplification unit is composed of a low noise amplifier amplifying a frequency signal received from the antenna.

The demodulator 315 demodulates an original code signal from the frequency signal inputted by the low noise amplification unit.

The base band processor 309 executes interleaving, block coding and convolution coding about the data, which are received through the demodulator 315 and the modulator 311, according to the GSM standard.

The LAPDm processor 307 processes control data which are received from the base station 107, according to the LAPDm standard.

The speaker 303 outputs an audible voice from the voice signal received from the opposite terminal. The microphone 301 converts the voice inputted by the recipient to an electronic voice signal.

The voice processor 305 converts the analogue voice signal, which is inputted from the microphone 301, into digital data. Also, the voice processor 305 converts the voice data, which are authenticated through the base band processor 309, into the analogue voice data and outputs the voice signal through the speaker 303.

The modulator 311 modulates the transmission data, which are outputted by the base band processor 309, to a frequency signal. The amplifier amplifies the frequency signal modulated by the modulator 311.

The key input unit 321 has plural number key and function key.

The indicator 325 displays the working state or the operation state of the terminal 109. For example, the indicator 325 is an LCD (liquid crystal display) and so on.

The controller 323 controls the state of the terminal 109 by transmitting and receiving with the base station 107 through the LAPDm processor 307. Also, the controller 323 controls the terminal 109 according to the operation signal which is inputted through the key input unit 321.

The working program of the controller 323 is stored in the program memory 327, and the processing data, which are related to the working of the controller 323, are stored in the data memory 329.

The A/D converter 319 converts the reception data, which are modulated by the modulator 315, to the digital data and outputs the data value corresponding to the reception data size to the controller 323. The data value is outputted in order to select a base station corresponding to the terminal 109 or providing hand-over.

The received caller's telephone number is stored in the caller identification memory 331, and the advertisement received together is stored in the advertisement memory 333.

The key input unit 321 has function keys for searching and selecting the stored caller's telephone number. The controller 323 stores the received caller's telephone number and calls to the caller in response to the recipient's call request. The program in which the controller 323 stores the caller's telephone number is stored in the program memory 327.

The caller identification memory 331 and the advertisement memory 333 have plural memory addresses and store numerical data serially. The pointer is located on the current stored memory address, and the location of the pointer is changed by the control of the controller 323. The caller identification(the caller's telephone number) and the advertisement corresponding to the pointer are displayed on the indicator 325.

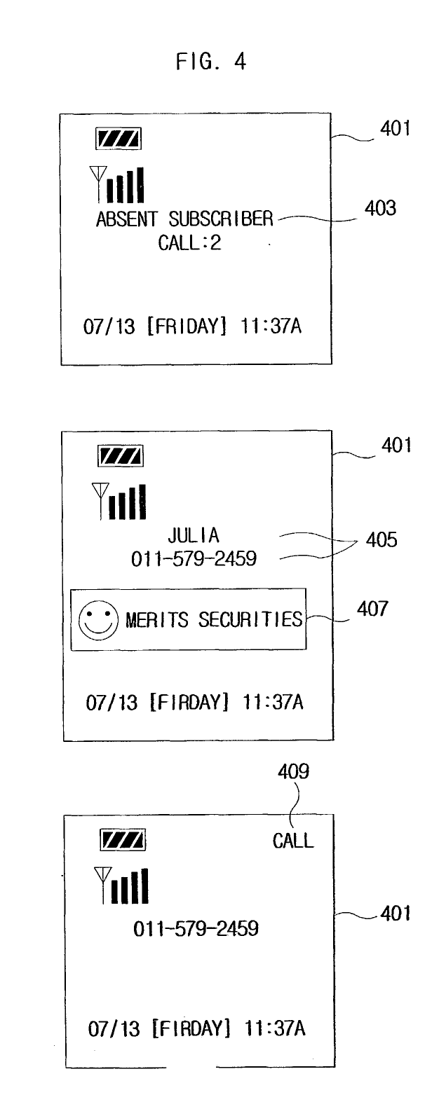

FIG. 4 is an example of the display monitor displaying the caller identification and the advertisement at a point in time in the present invention.

Referring to FIG. 4, the caller identification display service can be provided when the subscriber(recipient) is absent. The number of the absent subscriber call 403 is displayed on the LCD(liquid crystal display) 401 of the terminal 109. The subscriber can search the number of the absent subscriber call 403 by using the key input unit 321 of the terminal 109. The LCD(liquid crystal display) 401 of the terminal 109 can display the caller identification 405 and the advertisement 407 at a time. The caller identification 405 can be the caller's telephone number. If the caller's telephone number is stored on the address book of the terminal 109, then the LCD (liquid crystal display) 401 of the terminal 109 can display the caller's telephone number and the caller's information (name, address and so on) together.

At this point, the advertisement 407 can be extracted from the advertisement database 203 of the advertisement information providing apparatus 201 randomly, or the advertisement 407 which corresponds to the caller or the subscriber can be extracted.

For example, if the caller is ‘A company’, then the advertisement, which comprises a logo or a product corresponding to the company, can be transmitted to the subscriber's terminal 109. The advertisement information providing apparatus 201 extracts an advertisement corresponding to the subscriber's (recipient) information and provides the recipient with the caller identification and the advertisement. At this point, the subscriber's information can be stored on the member database of the mobile communication operator, and the subscriber's information can comprise a job, an age, a sex, an interest and so on.

Also, the subscriber can search the caller identification of the stored absent subscriber calls and call the caller corresponding to the caller identification.

Also, the caller identification comprising the advertisement can be displayed on the LCD(liquid crystal display) 401 of the terminal 109 when the call is received.

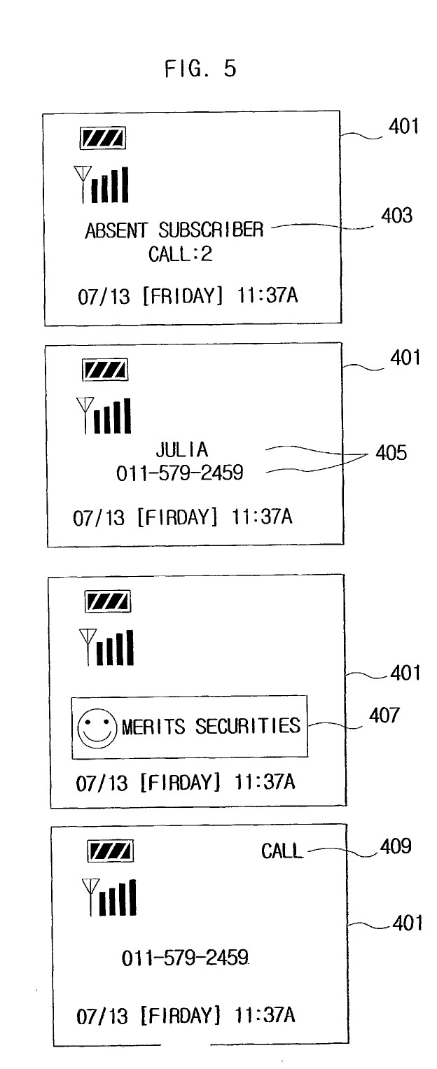

FIG. 5 is an example of the display monitor displaying the caller identification and the advertisement alternately in the present invention.

Referring to FIG. 5, the caller identification display service can be provided when the subscriber(recipient) is absent or the call is received.

The subscriber can search the number of the absent subscriber call 403 by using the key input unit 321 of the terminal 109. The LCD(liquid crystal display) 401 of the terminal 109 can display the caller identification 405 and the advertisement 407 alternately. At this point, the caller identification 405 and the advertisement 407 are the same as described on FIG. 4.

Also, the subscriber can search the caller identification of the stored absent subscriber calls and call the caller corresponding to the caller identification.

The caller identification 405 and the advertisement 407 can be displayed on the LCD(liquid crystal display) 401 of the terminal 109 alternately until the subscriber inputs the operation.

Also, the caller identification 405 and the advertisement 407 can be displayed on the LCD(liquid crystal display) 401 of the terminal 109 alternately when the call is received.

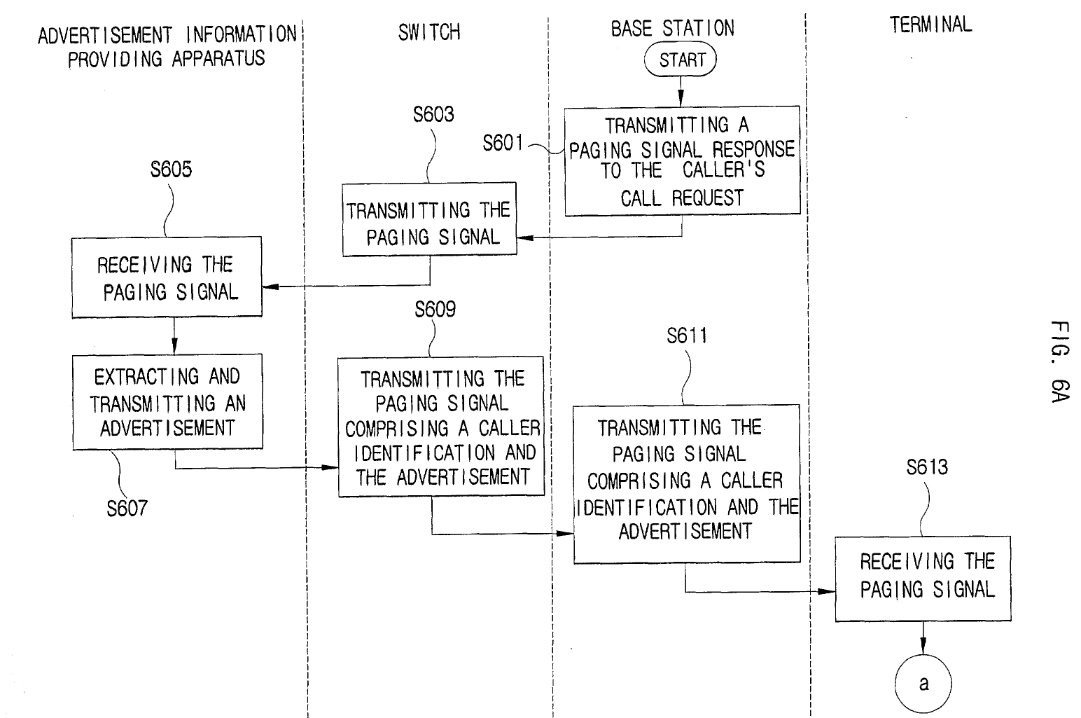

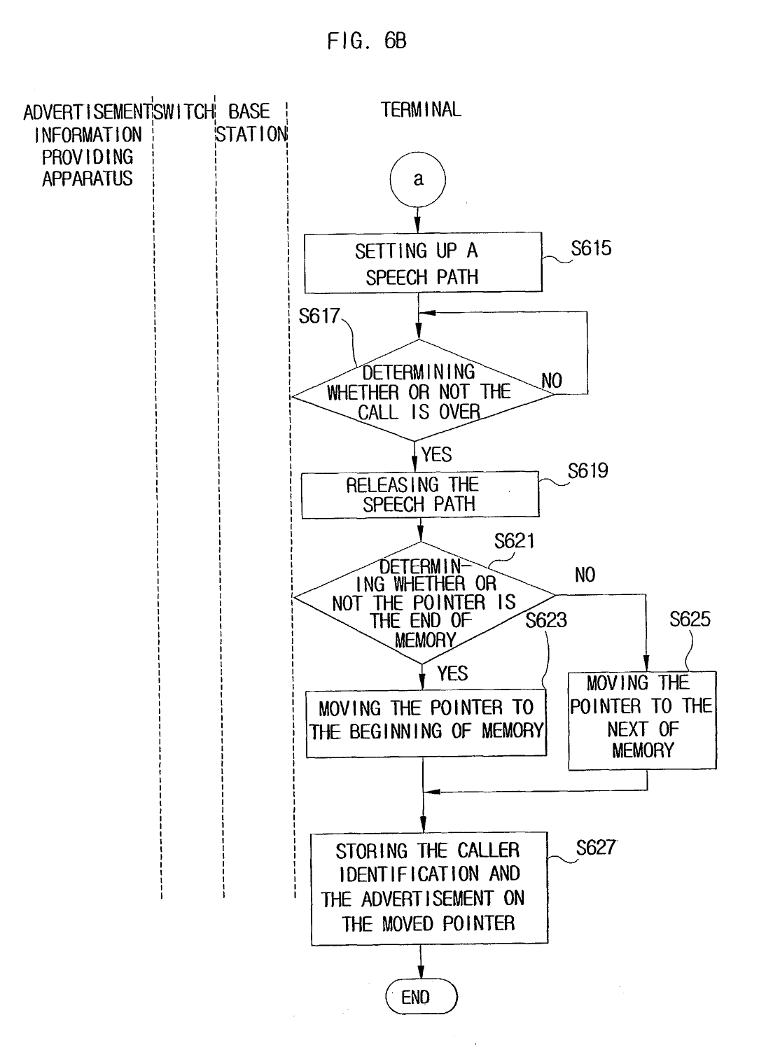

FIG. 6a and FIG. 6b comprise a flowchart illustrating the process of storing an advertisement provided in the caller identification display service of the present invention.

Referring to FIG. 6a and FIG. 6b, if the base station 107 transmits a paging signal response to the caller's call request to the switch 101(S601), then the switch 101 transmits the paging signal to the advertisement information providing apparatus 201(S603). The advertisement information providing apparatus 201 receives the paging signal(S605) and extracts an advertisement corresponding to the paging signal from the advertisement database 203 and transmits the advertisement to the switch 101(S607).

The switch 101 transmits the paging signal comprising caller identification and the advertisement to the base station 107(S609). If the base station 107 receives them, then the base station 107 transmits the paging signal comprising caller identification and the advertisement to the recipient's terminal 109(S611). If the recipient's terminal 109 receives the paging signal(S613), then the recipient's terminal 109 sets up a speech path(S615). The recipient's terminal 109 determines whether or not the call is over(S617) and if the call is over, then releases the speech path(S619).

If the speech path is released, then the recipient's terminal 109 determines whether or not the pointer is the end of memory(S621). If the pointer is the end of memory, then the terminal 109 moves the pointer to the beginning of memory(S623). If the pointer is not the end of memory, then the terminal 109 moves the pointer to the next of memory(S625). And the terminal 109 stores the caller identification and the advertisement on the moved pointer(S627).

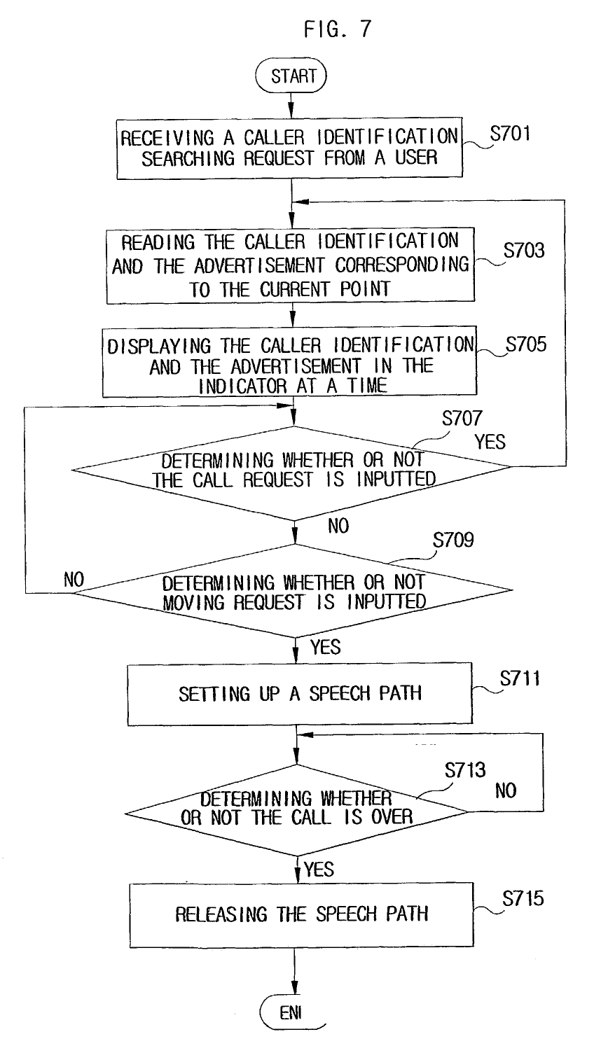

FIG. 7 is a flowchart illustrating the process of displaying the caller identification and the advertisement at a time in the present invention.

Referring to FIG. 7, if the subscriber's terminal 109 receives a request of searching a caller identification from a subscriber(S701), then the subscriber's terminal 109 extracts the caller identification and the advertisement corresponding to the current point(S703). The terminal 109 displays the caller identification and the advertisement on the LCD 401 of the terminal 109 at a time(S705) and determines whether or not a moving request will be inputted by the subscriber(S707).

If the moving request is inputted, then the terminal 109 moves the pointer and extracts the caller identification and the advertisement corresponding to the moved point(S703) and displays them on the LCD 401 of the terminal 109 at a time(S705).

If the moving request is not inputted, then the terminal accomplishes the procedures from the step S707 again.

The terminal 109 determines whether or not the call request is inputted(S709). If the call request is inputted, then the terminal 109 sets up a speech path between the caller corresponding to the caller identification and the recipient(S711). If the call between the caller and the recipient is over(S713), then the terminal releases the speech path(S715).

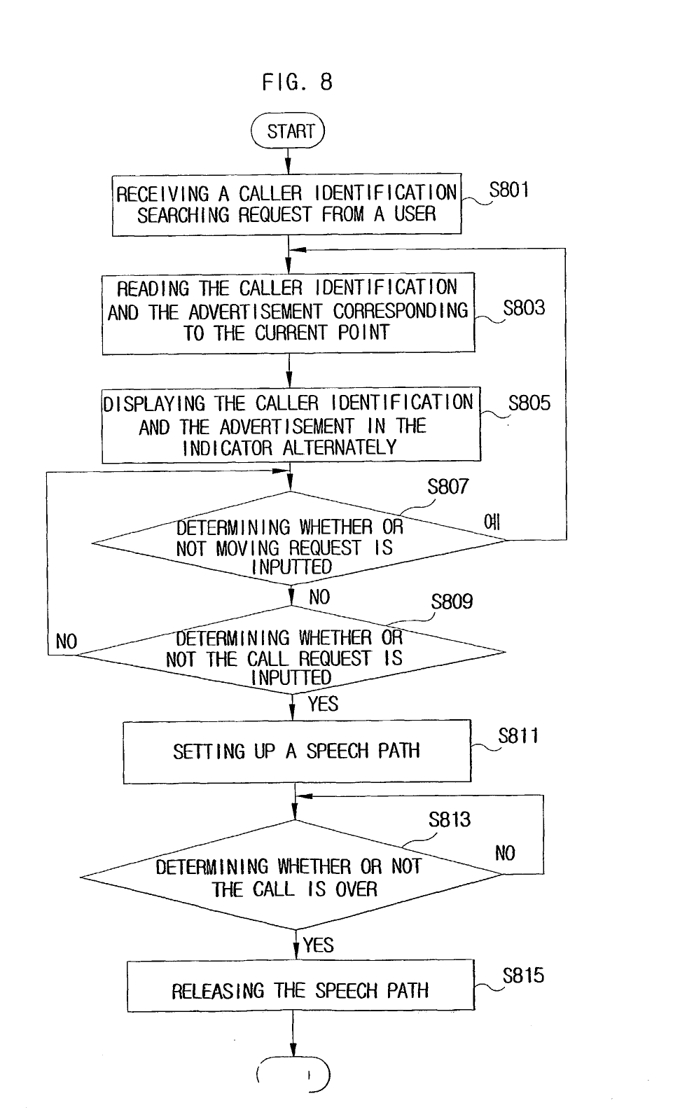

FIG. 8 is a flowchart illustrating the process of displaying the caller identification and the advertisement alternately in the present invention.

Referring to FIG. 8, if the subscriber's terminal 109 receives a request for searching a caller identification from a subscriber(S801), then extracts the caller identification and the advertisement corresponding to the current point(S803). The terminal 109 displays the caller identification and the advertisement on the LCD 401 of the terminal 109 alternately(S805) and determines whether or not the moving request will be inputted by the subscriber(S807).

If the moving request is inputted, then the terminal 109 moves the pointer and extracts the caller identification and the advertisement corresponding to the moved point(S803) and displays them on the LCD 401 of the terminal 109 alternately(S805).

If the moving request is not inputted, then the terminal accomplishes the procedures from the step S807 again.

The terminal 109 determines whether or not the call request is inputted(S809). If the call request is inputted, then the terminal 109 sets up a speech path between the caller corresponding to the caller identification and the recipient(S811). If the call between the caller and the recipient is over(S813), then the terminal releases the speech path(S815).

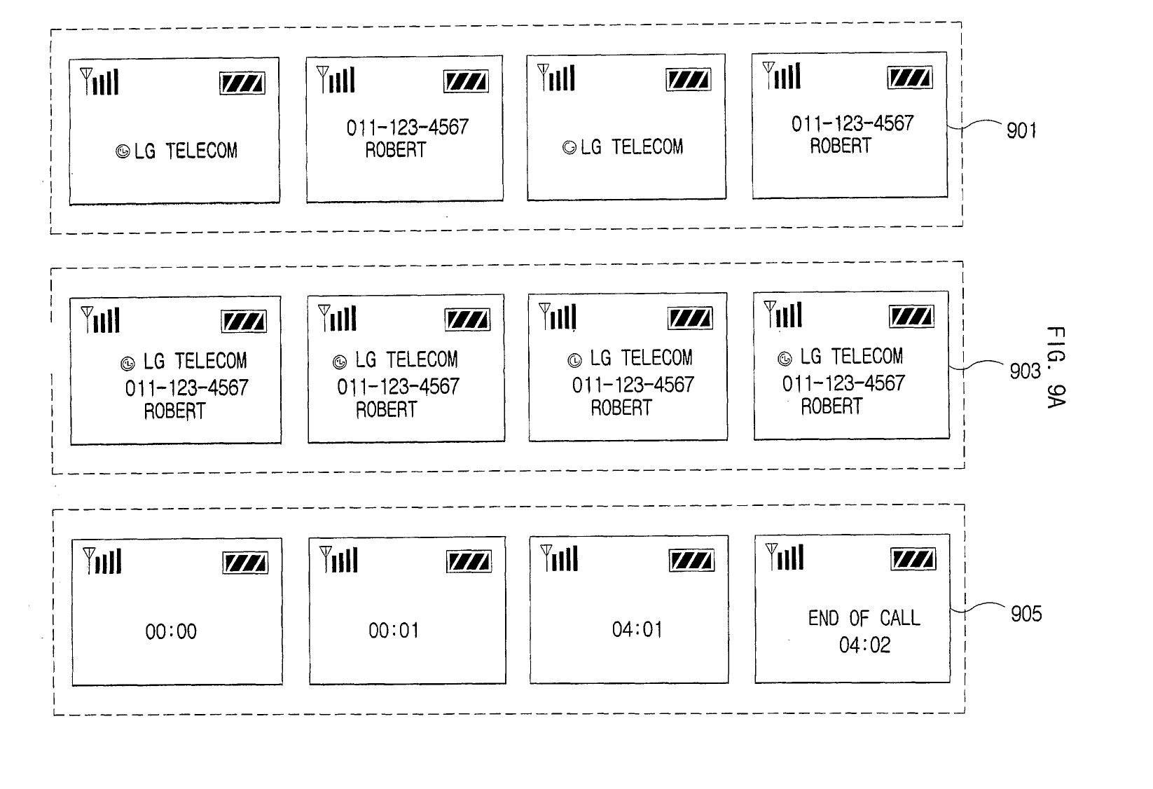

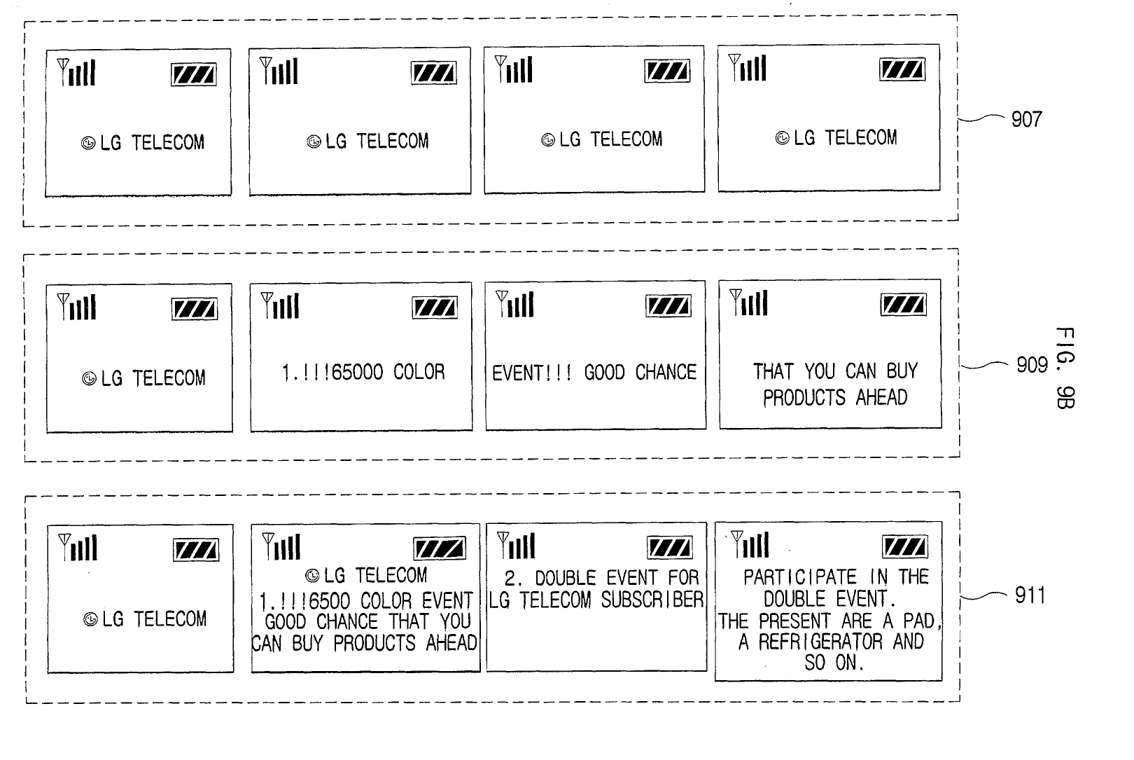

FIG. 9a and FIG. 9b comprise an example of the display monitor displaying the caller identification and the advertisement in the present invention.

Referring to FIG. 9a and FIG. 9b, if the recipient's telephone terminal 109 receives the advertisement and the caller identification from the base station 107, the advertisement and the caller identification are displayed on the indicator 325 of the terminal 109 like 901 and 903. Also, the terminal 109 stores the advertisement on the advertisement database 333 and stores the caller identification on the caller identification database 331. If the advertisement and the caller identification are stored, then the terminal 109 displays the information as described on 905 through the indicator and calls the caller. If the call is over, then the stored advertisement is displayed on the indicator 325 of the terminal 109 as described on 907 and 911.

According to another method of the present invention, if the subscriber's telephone terminal 109 receives the advertisement and the caller identification from the base station 109, then the terminal 109 displays the advertisement and the caller identification on the indicator 325 of the terminal 109 as described on 901 and 903 until the call begins. If the call is over, then the telecommunication operator transmits an output signal to the terminal 109. If the terminal receives the output signal, then the terminal displays the advertisement on the indicator 325 as described on 907 and 911.

The advertisement information providing apparatus 201 raises the transmission speed about the service of transmitting the caller identification and the advertisement. When the base station 107 transmits the caller identification and the advertisement for the first time, the base station 107 transmits the total data corresponding to the advertisement to the subscriber's terminal 109 in order to solve the difficulty of securing the speech path. At this point, the total data can be a text, an image, a moving picture and so on. Then the subscriber's terminal 109 receives the data and stores it with the caller identification. Also, the subscriber's terminal 109 receives the advertisement identification corresponding to the advertisement and stores it.

If the advertisement is stored on the terminal 109 as described above, the base station 107 transmits the caller identification and the advertisement identification. Then the terminal 109 receives the caller identification and the advertisement identification and stores them. The terminal 109 extracts the caller identification and the advertisement Corresponding to the advertisement identification in response to the subscriber's request and displays the caller identification and the advertisement.

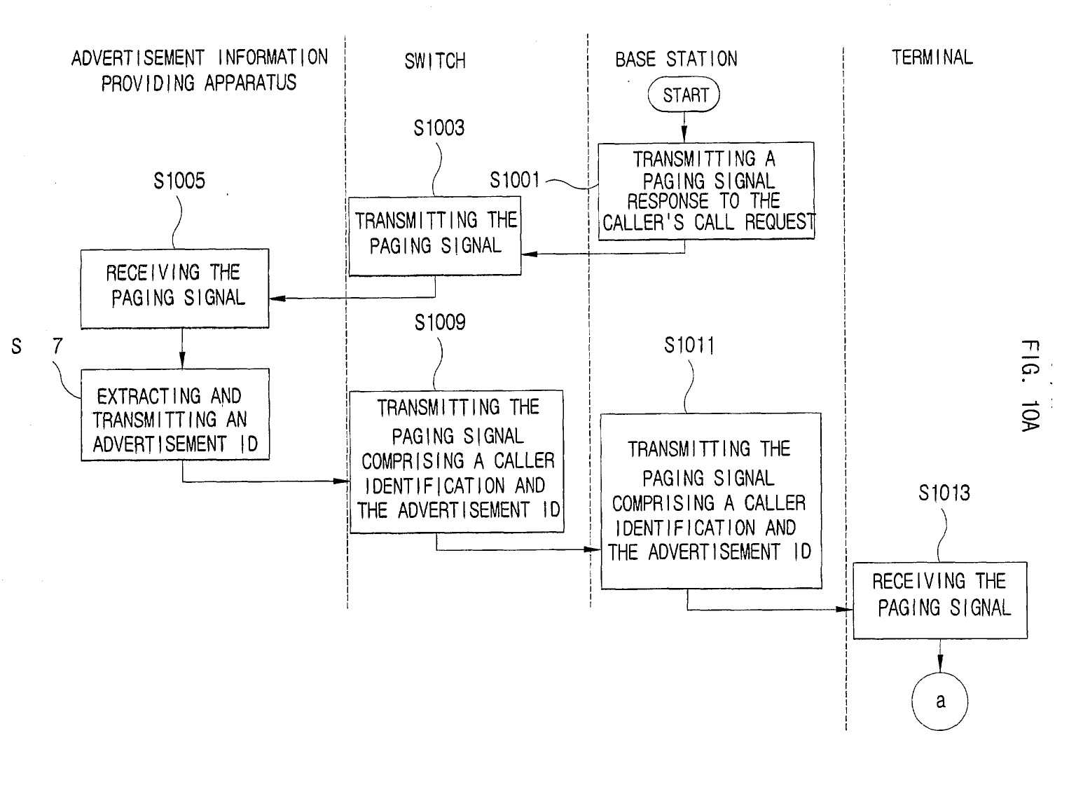

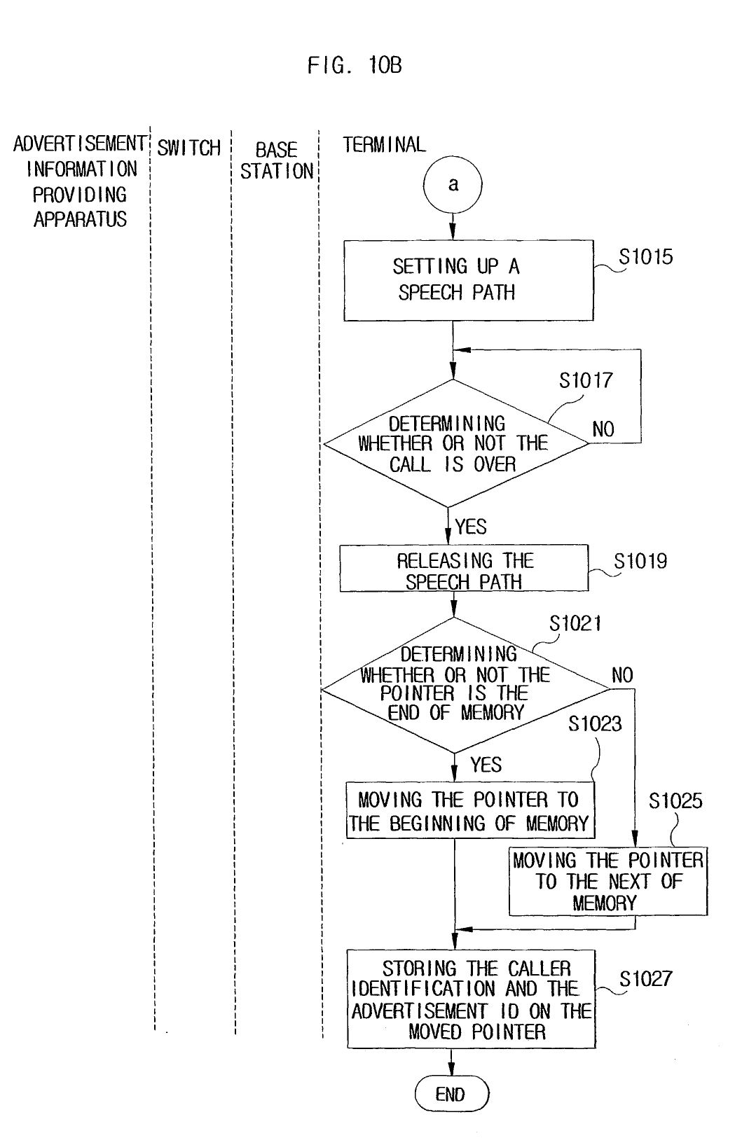

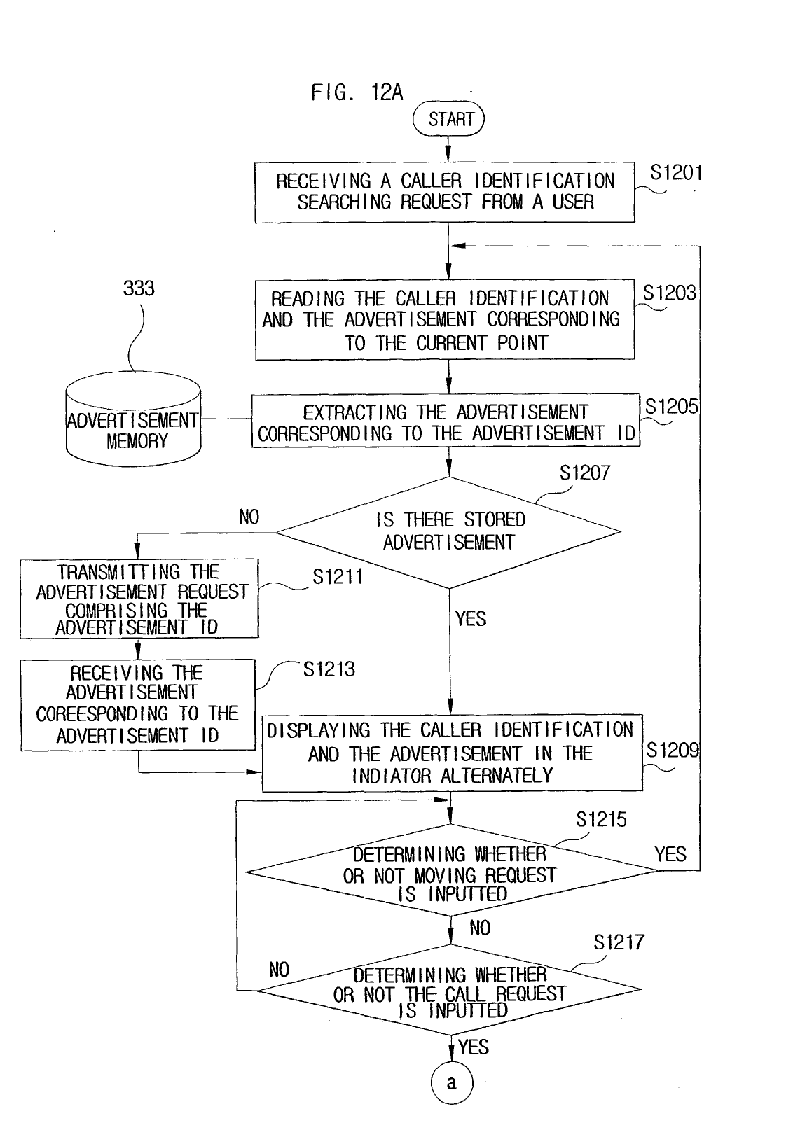

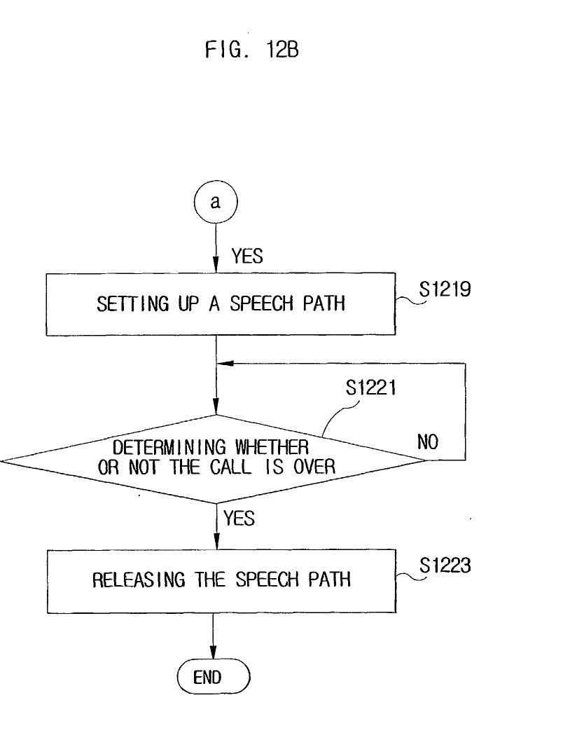

Hereinafter, the procedure of using the advertisement identification will be described in more detail with reference to FIG. 10a and FIG. 12b

FIG. 10a and FIG. 10b comprise the other flowchart illustrating the process of storing an advertisement provided in the caller identification display service of the present invention.

Referring to FIG. 10a and FIG. 10b, if the base station 107 transmits a paging signal in response to the caller's call request to the switch 101(S1001), then the switch 101 transmits the paging signal to the advertisement information providing apparatus 201(S1003). The advertisement information providing apparatus 201 receives the paging signal(S1005) and extracts an advertisement identification corresponding to the paging signal from the advertisement database 203 and transmits the advertisement identification to the switch 101(S1007).

The switch 101 transmits the paging signal comprising caller identification and the advertisement identification to the base station 107(S1009). If the base station 107 receives them, then the base station 107 transmits the paging signal comprising caller identification and the advertisement identification to the recipient's terminal 109(S1011).

If the recipient's terminal 109 receives the paging signal(S1013), then the recipient's terminal 109 sets up a speech path(S1015). The recipient's terminal 109 determines whether or not the call is over(S1017) and if the call is over, then releases the speech path(S1019).

If the speech path is released, then terminal 109 determines whether or not the pointer is the end of memory(S1021). If the pointer is the end of memory, then the terminal 109 moves the pointer to the beginning of memory(S1023). If the pointer is not the end of memory, then the terminal 109 moves the pointer to the next of memory(S1025). And the terminal 109 stores the caller identification and the advertisement identification on the moved pointer(S1027).

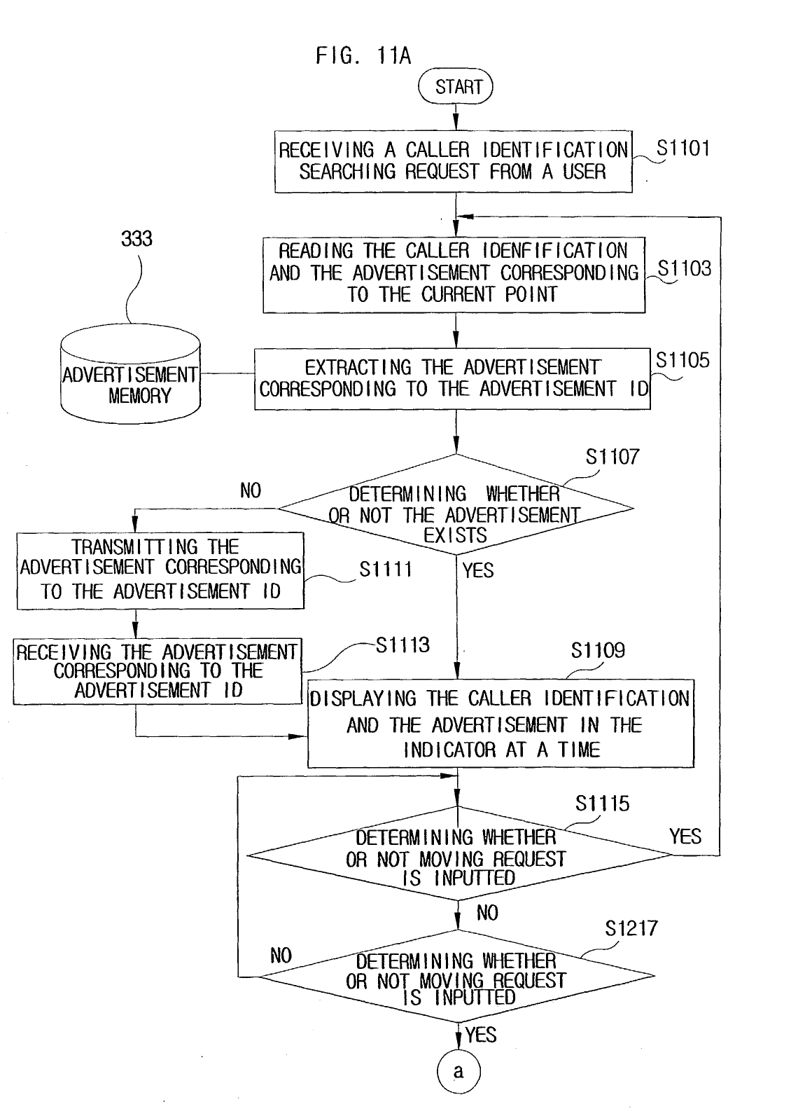

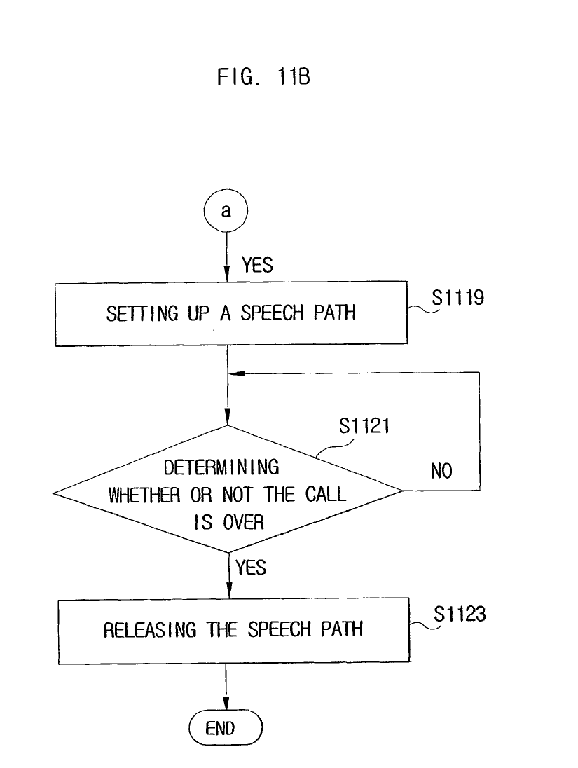

FIG. 11a and FIG. 11b comprise the other flowchart illustrating the process of displaying the caller identification and the advertisement at a time in the present invention.

FIG. 11a and FIG. 11b comprise the other flowchart illustrating the process of displaying the caller identification and the advertisement at a time in the present invention when using the advertisement identification.

Referring to FIG. 11a and FIG. 11b, if the subscriber's terminal 109 receives a request for searching caller identification from a subscriber(S1101), then the subscriber's terminal 109 extracts the caller identification and the advertisement identification corresponding to the current point(S1103). The terminal 109 extracts the advertisement corresponding to the advertisement identification from the advertisement memory 333(S1105) and determines whether or not the advertisement exists(S1107).

If the advertisement exists, then the terminal 109 displays the caller identification and the advertisement on the LCD 401 of the terminal 109 at a time(S1109). If the advertisement does not exist, then the terminal 109 transmits the advertisement request comprising the advertisement identification to the advertisement information providing apparatus 201(S1111). If the advertisement information providing apparatus 201 extracts an advertisement corresponding to the advertisement identification and transmits it to the terminal 109(S1113), then the terminal 109 displays the caller identification and the advertisement on the LCD 401 of the terminal 109 at a time(S1109).

Also, the terminal 109 determines whether or not moving request be inputted by the subscriber(S1115).

If the moving request is inputted, then the terminal 109 moves the pointer and extracts the caller identification and the advertisement corresponding to the moved point(S1103) and displays them on the LCD 401 of the terminal 109 at a time(S1109).

If the moving request is not inputted, then the terminal accomplishes the procedures from the step S1117.

The terminal 109 determines whether or not the call request is inputted(S1117). If the call request is inputted, then the terminal 109 sets up a speech path between the caller corresponding to the caller identification and the recipient(S1119). If the call between the caller and the recipient is over(S1121), then the terminal releases the speech path(S1123).

FIG. 12a and FIG. 12b comprise the other flowchart illustrating the process of displaying the caller identification and the advertisement alternately in the present invention.

FIG. 12a and FIG. 12b comprise the other flowchart illustrating the process of displaying the caller identification and the advertisement alternately in the present invention when using the advertisement identification

Referring to FIG. 12a and FIG. 12b, if the subscriber's terminal 109 receives a request for searching a caller identification from a subscriber(S1201), then the subscriber's terminal 109 extracts the caller identification and the advertisement identification corresponding to the current point(S1203). The terminal 109 extracts the advertisement corresponding to the advertisement identification from the advertisement memory 333(S1205) and determines whether or not the advertisement exists(S1207).

If the advertisement exists, then the terminal 109 displays the caller identification and the advertisement on the LCD 401 of the terminal 109 alternately(S1209). If the advertisement does not exist, then the terminal 109 transmits the advertisement request comprising the advertisement identification to the advertisement information providing apparatus 201(S1211). If the advertisement information providing apparatus 201 extracts an advertisement corresponding to the advertisement identification and transmits it to the terminal 109(S1213), then the terminal 109 displays the caller identification and the advertisement on the LCD 401 of the terminal 109 alternately(S1209).

Also, the terminal 109 determines whether or not moving request will be inputted by the subscriber(S1215).

If the moving request is inputted, then the terminal 109 moves the pointer and extracts the caller identification and the advertisement corresponding to the moved point(S1203) and displays them on the LCD 401 of the terminal 109 alternately(S1209).

If the moving request is not inputted, then the terminal accomplishes the procedures from the step S1217.

The terminal 109 determines whether or not the call request is inputted(S1217). If the call request is inputted, then the terminal 109 sets up a speech path between the caller corresponding to the caller identification and the recipient(S1219). If the call between the caller and the recipient is over(S1221), then the terminal releases the speech path(S1223).

Industrial Applicability

As described above according to the present invention, the present invention can provide a caller identification display method and system for displaying not only the caller identification(the caller's telephone number) but also additional information like an advertisement.

Also, the present invention can provide a caller identification display method and system in which the telecommunications operator provides the caller identification and an advertisement together.

Also, the present invention can provide a caller identification display method and system whereby the recipient can perceive the caller's identification of the call which came from a stranger(a strange person or a strange company), by displaying not only the caller's telephone number but also an advertisement or an image corresponding to the caller on the recipient's telephone terminal.

What is claimed is:

1. A method for displaying a caller identification and additional information on a recipient's telephone terminal, comprising the steps of:
receiving a call request from a caller's telephone terminal;
extracting the additional information corresponding to the caller identification from a database in response to the call request; and
transmitting a paging signal comprising the additional information and the caller identification to the recipient's telephone terminal, wherein the additional information and the caller identification are displayed on the recipient's telephone terminal.

2. The method of claim 1, wherein the additional information and the caller identification are stored on the recipient's telephone terminal.

3. The method of claim 2, wherein the stored additional information is searched and selected by the recipient's key input.

4. The method of claim 1, wherein the recipient's telephone terminal displays the additional information and the caller identification on an indicator of the terminal at a time.

5. The method of claim 1, wherein the recipient's telephone terminal alternately displays the additional information and the caller identification on the indicator of the terminal.

6. The method of claim 1, wherein the additional information is extracted from at least one selected within a group consisting of the recipient and the caller.

7. The method of claim 1, wherein the additional information is extracted corresponding to the caller identification.

8. The method of claim 1, wherein the additional information is at least one selected from a group consisting of an advertisement, a notice, news, a mail address, information, and a service.

9. The method of claim 1, wherein the recipient's telephone terminal calls the caller corresponding to the caller identification response to the recipient's key input.

10. The method of claim 1, wherein the caller identification is at least one selected from a group consisting of the caller's telephone number, subscriber identification, a name, and a mail address.

11. A method for displaying a caller identification and additional information on a recipient's telephone terminal, comprising the steps of:
receiving a paging signal comprising a caller identification and additional information corresponding to the caller;
setting up a speech path of the caller's telephone terminal corresponding to the caller identification;
determining whether or not the call is over;
determining whether or not the pointer is the end of memory after the call is over;
when the pointer is the end of memory then moving the pointer to the beginning of memory, and when the pointer is not the end of memory then moving the pointer to the next of memory;
storing the caller identification and the additional information on the moved pointer;
receiving a caller identification-searching request from the recipient;
reading the caller identification and the additional information corresponding to the current point; and
displaying the caller identification and the additional information in the indicator at a time.

12. A method for storing a caller identification and additional information on a recipient's telephone terminal, comprising the steps of:
receiving a paging signal comprising a caller identification and additional information corresponding to the caller;
setting up a speech path of the caller's telephone terminal corresponding to the caller identification;
determining whether or not the call is over;
determining whether or not the pointer is the end of memory after the call is over;
if the pointer is the end of memory then moving the pointer to the beginning of memory, but if the pointer is not the end of memory then moving the pointer to the next of memory; and
storing the caller identification and the additional information on the moved pointer, wherein the additional information is displayed on the recipient's telephone terminal in response to the recipient's searching request.

13. The method of claim 12, wherein the recipient's telephone terminal displays the additional information and the caller identification on the indicator of the terminal at a time.

14. The method of claim 12, wherein the recipient's telephone terminal alternately displays the additional information and the caller identification on the indicator of the terminal.

15. The method of claim 12, wherein a telecommunication operator corresponding to the recipient's telephone terminal randomly extracts the additional information.

16. The method of claim 12, wherein the additional information is extracted from at least the recipient or the caller.

17. The method of claim 12, wherein the additional information is extracted corresponding to the caller identification.

18. The method of claim 12, wherein the additional information is at least one selected from a group consisting of an advertisement, a notice, news, a mail address, information, and a service.

19. The method of claim 12, wherein the recipient's telephone terminal calls the caller corresponding to the caller identification in response to the recipient's key input.

20. The method of claim 12, wherein the caller identification is at least one selected from a group consisting of the caller's telephone number, subscriber identification, a name, and a mail address.

21. A method for displaying a caller identification and additional information on a recipient's telephone terminal, comprising the steps of:
receiving a caller identification-searching request from the recipient;
extracting the caller identification and the additional information corresponding to the current point from the memory of the recipient's telephone terminal; and
displaying the caller identification and the additional information in the indicator of the recipient's telephone terminal, wherein the caller identification and the additional information are stored on the recipient's telephone terminal in response to the call request received from the caller's telephone terminal.

22. The method of claim 21, wherein the recipient's telephone terminal displays the additional information and the caller identification on the indicator of the terminal at a time.

23. The method of claim 21, wherein the recipient's telephone terminal alternately displays the additional information and the caller identification on the indicator of the terminal.

24. The method of claim 21, wherein a telecommunication operator corresponding to the recipient's telephone terminal randomly extracts the additional information.

25. The method of claim 21, wherein the additional information is extracted at least from the recipient or the caller.

26. The method of the claim 21, the additional information is extracted corresponding to the caller identification.

27. The method of claim 21, wherein the method for displaying a caller identification and additional information, further comprising the steps of:
receiving a call request from the recipient; and
setting up a speech path of the caller's telephone terminal corresponding to the caller identification.

28. The method of claim 21, wherein the additional information is at least one selected from a group consisting of an advertisement, a notice, news, a mail address, information, and a service.

29. The method of claim 21, wherein the recipient's telephone terminal calls the caller corresponding to the caller identification response to the recipient's key input.

30. The method of claim 21, wherein the caller identification is at least one selected from a group consisting of the caller's telephone number, subscriber identification, a name, and a mail address.

31. A method for displaying a caller identification and additional information on a recipient's telephone terminal, comprising the steps of:
receiving a call request from the recipient;
extracting the additional information identification corresponding to the caller identification from a database in response to the call request; and
transmitting a paging signal comprising the additional information identification and the caller identification to the recipient's telephone terminal, wherein the additional information corresponding to the additional information identification and the caller identification are displayed on the recipient's telephone terminal.

32. A method for displaying a caller identification and additional information on a recipient's telephone terminal, comprising the steps of:
receiving a paging signal comprising a caller identification and additional information identification corresponding to the caller;
setting up a speech path of the caller's telephone terminal corresponding to the caller identification;
determining whether or not the call is over;
determining whether or not the pointer is the end of memory after the call is over;
if the pointer is the end of memory then moving the pointer to the beginning of memory, but if the pointer is not the end of memory then moving the pointer to the next of memory;
storing the caller identification and the additional information identification on the moved pointer;
receiving a caller identification-searching request from the recipient;
reading the caller identification and the additional information identification corresponding to the current point;
extracting the additional information corresponding to the additional information identification from the memory of the recipient's telephone terminal; and
displaying the caller identification and the additional information in the indicator at a time, wherein the additional information is stored corresponding to the additional information identification, and if the extracted additional information does not exist, then the recipient's telephone terminal transmits an additional information request comprising the additional information identification to the additional information providing apparatus.

33. A method for storing a caller identification and additional information on a recipient's telephone terminal, comprising the steps of:
receiving a paging signal comprising a caller identification and additional information identification corresponding to the caller;
setting up a speech path of the caller's telephone terminal corresponding to the caller identification;
determining whether or not the call is over;
determining whether or not the pointer is the end of memory after the call is over;
if the pointer is the end of memory then moving the pointer to the beginning of memory, but if the pointer is not the end of memory then moving the pointer to the next of memory; and
storing the caller identification and the additional information identification on the moved pointer, wherein the additional information corresponding to the additional information identification is extracted in response to the caller identification searching request of the recipient and displayed on the recipient's telephone terminal, and if the extracted additional information does not exist, then the recipient's telephone terminal transmits an additional information request comprising the additional information identification to the additional information providing apparatus.

34. A method for displaying a caller identification and additional information on a recipient's telephone terminal, comprising the steps of:
receiving a caller identification-searching request from the recipient;
extracting the caller identification and the additional information identification corresponding to the current point from the memory of the recipient's telephone terminal;
extracting the additional information corresponding to the additional information identification from the memory of the recipient's telephone terminal; and
displaying the caller identification and the additional information in the indicator of the recipient's telephone terminal, wherein the caller identification and the additional information identification are stored on the recipient's telephone terminal in response to the call request received from the caller's telephone terminal, and the additional information is stored corresponding to the additional information identification, and if the extracted additional information does not exist, then the recipient's telephone terminal transmits an additional information request comprising the additional information identification to the additional information providing apparatus.

35. A system for displaying a caller identification and additional information on a recipient's telephone terminal, the system comprising:
means for receiving a call request from a caller's telephone terminal;
means for extracting the additional information corresponding to the caller identification from a database in response to the call request; and
means for transmitting a paging signal comprising the additional information and the caller identification to the recipient's telephone terminal, wherein the additional information and the caller identification are displayed on the recipient's telephone terminal.

36. A system for displaying a caller identification and additional information on a recipient's telephone terminal, the system comprising:
means for receiving a paging signal comprising a caller identification and additional information corresponding to the caller;
means for setting up a speech path of the caller's telephone terminal corresponding to the caller identification;
means for determining whether or not the call is over;
means for determining whether or not the pointer is the end of memory after the call is over;
if the pointer is the end of memory then means for moving the pointer to the beginning of memory, but if the pointer is not the end of memory then means for moving the pointer to the next of memory;
means for storing the caller identification and the additional information on the moved pointer;
means for receiving a caller identification searching request from the recipient;
means for reading the caller identification and the additional information corresponding to the current point; and
means for displaying the caller identification and the additional information in the indicator at a time.

37. A system for storing a caller identification and additional information on a recipient's telephone terminal, the system comprising:
means for receiving a paging signal comprising a caller identification and additional information corresponding to the caller;
means for setting up a speech path of the caller's telephone terminal corresponding to the caller identification;
means for determining whether or not the call is over;
means for determining whether or not the pointer is the end of memory after the call is over;
if the pointer is the end of memory then means for moving the pointer to the beginning of memory, but if the pointer is not the end of memory then means for moving the pointer to the next of memory; and
means for storing the caller identification and the additional information on the moved pointer, wherein the additional information is displayed on the recipient's telephone terminal in response to the recipient's searching request.

38. A system for displaying a caller identification and additional information on a recipient's telephone terminal, the system comprising:
means for receiving a caller identification searching request from the recipient;
means for extracting the caller identification and the additional information corresponding to the current point from the memory of the recipient's telephone terminal; and
means for displaying the caller identification and the additional information in the indicator of the recipient's telephone terminal, wherein the caller identification and the additional information are stored on the recipient's telephone terminal in response to the call request received from the caller's telephone terminal.

39. A system for displaying a caller identification and additional information on a recipient's telephone terminal, the system comprising:
means for receiving a call request from the recipient;
means for extracting the additional information identification corresponding to the caller identification from a database in response to the call request; and
means for transmitting a paging signal comprising the additional information identification and the caller identification to the recipient's telephone terminal, wherein the additional information corresponding to the additional information identification and the caller identification are displayed on the recipient's telephone terminal.

40. A system for displaying a caller identification and additional information on a recipient's telephone terminal, the system comprising:
means for receiving a paging signal comprising a caller identification and additional information identification corresponding to the caller;
means for setting up a speech path of the caller's telephone terminal corresponding to the caller identification;
means for determining whether or not the call is over;
means for determining whether or not the pointer is the end of memory after the call is over;
if the pointer is the end of memory then means for moving the pointer to the beginning of memory, but if the pointer is not the end of memory then means for moving the pointer to the next of memory;
means for storing the caller identification and the additional information identification on the moved pointer;
means for receiving a caller identification searching request from the recipient;
means for reading the caller identification and the additional information identification corresponding to the current point;
means for extracting the additional information corresponding to the additional information identification from the memory of the recipient's telephone terminal; and
means for displaying the caller identification and the additional information in the indicator at a time, wherein the additional information is stored corresponding to the additional information identification, and if the extracted additional information does not exist, then the recipient's telephone terminal transmits an additional information request comprising the additional information identification to the additional information providing apparatus.

41. A system for storing a caller identification and additional information on a recipient's telephone terminal, the system comprising:
means for receiving a paging signal comprising a caller identification and additional information identification corresponding to the caller;
means for setting up a speech path of the caller's telephone terminal corresponding to the caller identification;
means for determining whether or not the call is over;
means for determining whether or not the pointer is the end of memory after the call is over;
if the pointer is the end of memory then means for moving the pointer to the beginning of memory, but if the pointer is not the end of memory then means for moving the pointer to the next of memory; and
means for storing the caller identification and the additional information identification on the moved pointer, wherein the additional information corresponding to the additional information identification is extracted response to the caller identification searching request of the recipient and displayed on the recipient's telephone terminal, and if the extracted additional information does not exist, then the recipient's telephone terminal transmits an additional information request comprising the additional information identification to the additional information providing apparatus.

42. A system for displaying a caller identification and additional information on a recipient's telephone terminal, the system comprising:
means for receiving a caller identification searching request from the recipient;
means for extracting the caller identification and the additional information identification corresponding to the current point from the memory of the recipient's telephone terminal;
means for extracting the additional information corresponding to the additional information identification from the memory of the recipient's telephone terminal; and
means for displaying the caller identification and the additional information in the indicator of the recipient's telephone terminal, wherein the caller identification and the additional information identification are stored on the recipient's telephone terminal in response to the call request received from the caller's telephone terminal, and the additional information is stored corresponding to the additional information identification, and if the extracted additional information does not exist, then the recipient's telephone terminal transmits an additional information request comprising the additional information identification to the additional information providing apparatus.

43. A caller identification displaying system, the system comprising:
a storage device; and
a processor coupled to the storage device,
the storage device storing a program for controlling the processor; and
the processor operative with the program to receive a call request from a caller's telephone terminal;
extract additional information corresponding to the caller identification from a database in response to the call request; and
transmit a paging signal comprising the additional information and the caller identification to the recipient's telephone terminal, wherein the additional information and the caller identification are displayed on the recipient's telephone terminal.

44. A caller identification displaying system, the system comprising:
a storage device; and
a processor coupled to the storage device,
the storage device storing a program for controlling the processor; and
the processor operative with the program to receive a paging signal comprising a caller identification and additional information corresponding to the caller;
set up a speech path of the caller's telephone terminal corresponding to the caller identification;
determine whether or not the call is over;
determine whether or not the pointer is the end of memory after the call is over;
if the pointer is the end of memory then move the pointer to the beginning of memory, but if the pointer is not the end of memory then move the pointer to the next of memory;
store the caller identification and the additional information on the moved pointer;
receive a caller identification-searching request from the recipient;
read the caller identification and the additional information corresponding to the current point; and
display the caller identification and the additional information in the indicator at a time.

45. A caller identification storing system, the system comprising:
a storage device; and
a processor coupled to the storage device,
the storage device storing a program for controlling the processor; and
the processor operative with the program to receive a paging signal comprising a caller identification and additional information corresponding to the caller;
set up a speech path of the caller's telephone terminal corresponding to the caller identification;
determine whether or not the call is over;
determine whether or not the pointer is the end of memory after the call is over;
if the pointer is the end of memory then move the pointer to the beginning of memory, but if the pointer is not the end of memory then move the pointer to the next of memory; and
store the caller identification and the additional information on the moved pointer, wherein the additional information is displayed on the recipient's telephone terminal in response to the recipient's searching request.

46. A caller identification displaying system, the system comprising:
a storage device; and
a processor coupled to the storage device,
the storage device storing a program for controlling the processor; and
the processor operative with the program to receive a caller identification-searching request from the recipient;
extract the caller identification and the additional information corresponding to the current point from the memory of the recipient's telephone terminal; and
display the caller identification and the additional information in the indicator of the recipient's telephone terminal, wherein the caller identification and the additional information are stored on the recipient's telephone terminal in response to the call request received from the caller's telephone terminal.
